(19) United States
(12) Patent Application Publication
(10) Pub. No.: US 2026/0271156 A1
(43) Pub. Date: Sep. 10, 2026

(54) FAIL-SAFE LED LAMP ASSEMBLY

(71) Applicant: Peterson Manufacturing Company, Grandview, MO (US)

(72) Inventor: Rhett Andrew Peterson, Lees Summit, MO (US)

(21) Appl. No.: 19/556,345

(22) Filed: Mar. 4, 2026

Related U.S. Application Data
(60) Provisional application No. 63/766,447, filed on Mar. 4, 2025.

(51) Int. Cl. H05B 45/46; B60Q 1/26; F21S 43/14

(52) U.S. Cl. CPC H05B 45/46; B60Q 1/2696; F21S 43/14

(57) ABSTRACT

To provide a fail-safe lamp, an illumination circuit may include paralleled strings of LEDs running side by side on a circuit board. If one or more LEDs fail in one string, an evenly split drive current between the paired strings of LEDs shifts so that the remaining intact string of LEDs now receives the entirety of the drive current, causing the secondary string of LEDs to increase their illumination. Coupled with the lamp lensing, the remaining LED string maintains enough illumination to appear fully operational and to pass photometric requirements of the lamp. The coupled LED strings may be connected in parallel to share a drive current such that, when an LED fails, the remaining LED strings may receive more drive current to maintain the illumination of the fail-safe lamp.

### CROSS-REFERENCE TO RELATED APPLICATION

This application claims priority to U.S. Provisional Patent Application No. 63/766,447, filed Mar. 4, 2025, entitled “FAIL-SAFE LED LAMP ASSEMBLY,” the entire disclosure of which is hereby incorporated by reference, for all purposes, as if fully set forth herein.

### TECHNICAL FIELD

This disclosure relates to the field of vehicle electronics and, in particular, this disclosure relates to a fail-safe indicator light of a vehicle.

### BACKGROUND AND INTRODUCTION

Many laws mandate that vehicles have various safety lights, such as headlights, brake lights, turn signal lights, running lights, etc. In many instances, the brightness, placement, and operation of such light assemblies is also mandated by law. However, due to the outdoor conditions that many vehicles operate, failure of one or more bulbs or other light emitting devices within the light assemblies is common and replacement is required. However, until a replacement assembly can be obtained and mounted on the vehicle, the broken light assembly may not satisfy the required standards, opening the driver of the vehicle to possible fines for an improper lamp assembly.

Some or all of these and other issues are addressed by various aspects of the present disclosure discussed in detail below.

### SUMMARY

Aspects of the present disclosure involve a lamp assembly for a vehicle comprising a mounting bracket for mounting the lamp assembly to the vehicle, a lens connected to the mounting bracket to form an interior of the lamp assembly, and a lighting circuit within the interior of the lamp assembly. The lighting circuit may include a first LED in electrical communication with a first power rail to receive a first power signal from a power source connected to the first power rail, the first power signal comprising a current component and a second LED connected in parallel with the first LED, the second LED in electrical communication with the first power rail to receive the first power signal from the power source, the current component of the power signal shared between the first LED and the second LED. Upon failure of the first LED, the current component of the power signal is transmitted to the second LED.

Another aspect of the present disclosure involves a method for a providing illumination from a vehicular lamp assembly, the method comprising mounting, via a mounting bracket, the vehicular lamp assembly to a vehicle, the vehicle lamp assembly comprising the mounting bracket, a lens, and a lighting circuit contained within the vehicular lamp assembly between the mounting bracket and the lens and connecting a power source to the vehicular lamp assembly via one or more power connectors of the lighting circuit. The lighting circuit of the lamp assembly may include a circuit board, a first LED on the circuit board and in electrical communication with a first power rail to receive a first power signal from a power source connected to the first power rail via the one or more power connectors, the first power signal comprising a current component, and a second LED on the circuit board and connected in parallel with the first LED, the second LED in electrical communication with the first power rail to receive the first power signal from the power source via the one or more power connectors, the current component of the power signal shared between the first LED and the second LED. Upon failure of the first LED, the current component of the power signal is transmitted to the second LED.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 is a representative isometric view of a fail-safe indicator light for a vehicle with redundancy according to aspects of the present disclosure.

FIG. 2 is a representative front view of a fail-safe indicator light for a vehicle with redundancy according to aspects of the present disclosure.

FIG. 3 is a representative circuit for a fail-safe indicator light for a vehicle with redundancy according to aspects of the present disclosure.

FIG. 4 is a representative flowchart of a method for utilizing a redundant, fail-safe indicator light of vehicle according to aspects of the present disclosure.

FIG. 5 is a representative circuit for a second fail-safe indicator light for a vehicle with redundancy according to another embodiment of the present disclosure.

### DETAILED DESCRIPTION

Aspects of this disclosure are directed to a redundant, fail-safe lamp utilizing redundant strings of light emitting diodes (LEDs) in order to ensure that photometric operation is maintained from the light in the event of an LED string failure. In one particular implementation, the fail-safe lamp may be included in an indicator light assembly for a vehicle, such as a brake light, a running light, a headlight, an interior light, etc. However, aspects of the fail-safe lamp discussed herein may be included with any illumination device or lamp. Thus, although discussed herein with reference to a vehicle indicator light, it should be appreciated that the circuits, methods, and systems described may be utilized in other aspects in which a fail-safe lamp is needed.

To provide the fail-safe lamp, an illumination circuit may include paralleled strings of LEDs running side by side on a circuit board so that drive currents and optical lenses are shared equally between paired strings. If one or more LEDs fail in one string, an evenly split drive current between the paired strings of LEDs shifts so that the remaining intact string of LEDs now receives the entirety of the drive current, causing the secondary string of LEDs to increase their illumination. Coupled with the lamp lensing, the remaining LED string maintains enough illumination to appear fully operational and to pass photometric requirements of the lamp. In some instances, the redundant strings of LEDs may include more than two paired strings, such as three strings, four strings, etc. Regardless, the coupled LED strings may be connected in parallel to share a drive current such that, when an LED fails, the remaining LED strings may receive more drive current to maintain the illumination of the fail-safe lamp. In this manner, the fail-safe lamp may remain fully operational and capable of providing photometric requirements despite the failure of one or more LED strings.

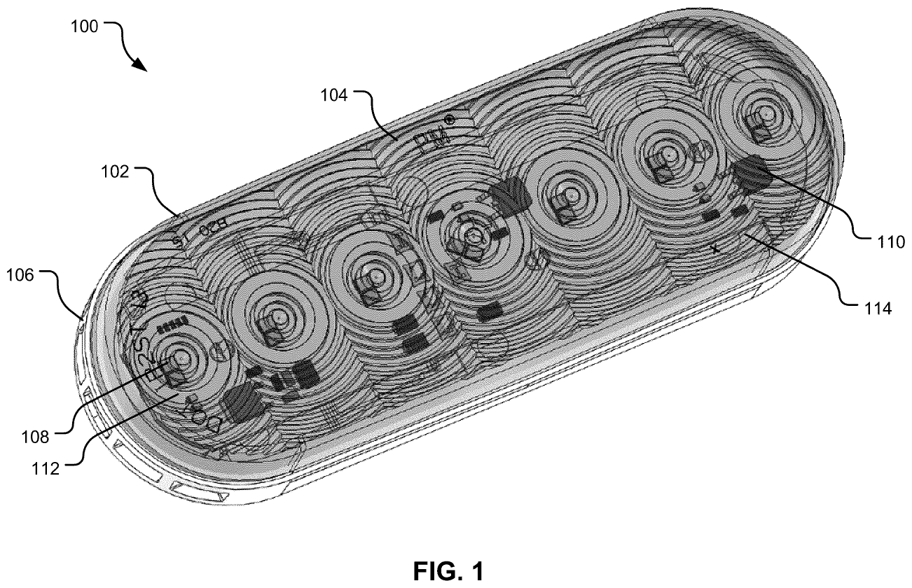

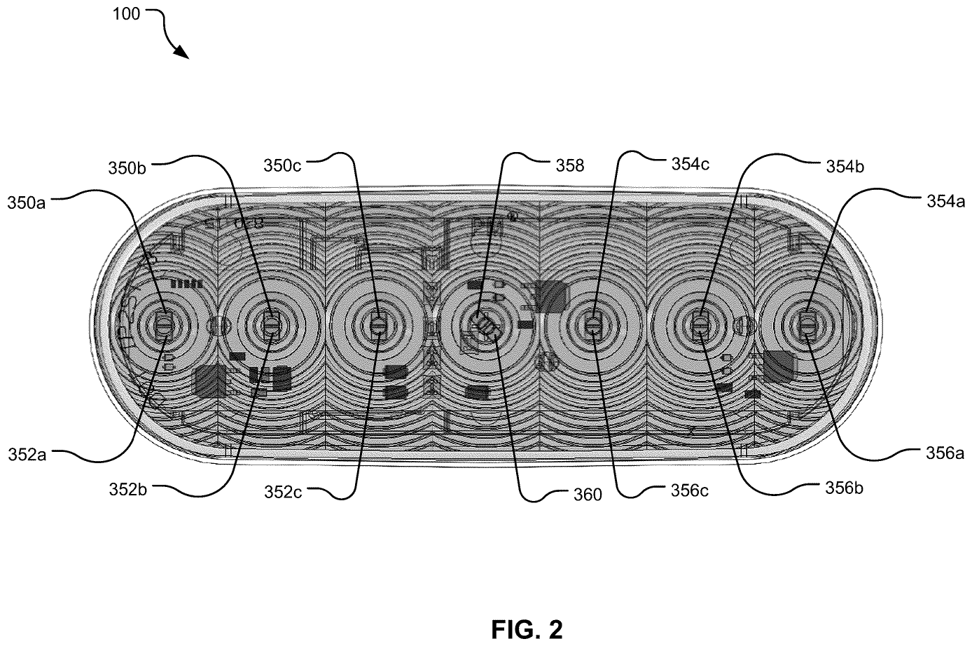

To begin, FIG. 1 illustrates a representative isometric view of a fail-safe indicator lamp 100 for a vehicle with redundancy and FIG. 2 is a representative front view of the fail-safe indicator lamp. As described above, the indicator light 100 of FIGS. 1 and 2 are one example of a type of lamp that may utilize the methods and circuits described herein. The particular example illustrated in FIGS. 1 and 2 is a brake light assembly for a vehicle. However, other types of lamps, vehicle or otherwise, are contemplated. The indicator lamp assembly 100 may include a housing 102 for the fail-safe circuit. The housing 102 may include a lens 104 and a mounting bracket 106. The lens 104 may be forward facing and comprise a transparent, translucent, or partially opaque material such that light generated from LEDs 108 within the housing 102 may be illuminated through the lens. In some instances, the lens 104 may be tinted with some coloring, such as red or yellow. The mounting bracket 106 may be rearward facing to mount the assembly 100 to a vehicle or other structure. For example, the bracket 106 may include one or more mounting devices, such as pins, clips, screws, snaps, etc. to mount the assembly 100 in a corresponding receptacle of a vehicle. In some instances, the bracket 106 may also include one or more conducting pins, plugs, receptacles, etc. for receiving a power signal from the vehicle. As described in more detail below, a battery of a vehicle may provide power to the illumination circuit contained within the assembly 100 to cause one or more LEDs 108 of the assembly to become illuminated and shine light through the lens 104. In some instances, the lamp assembly 100 may include an internal power source to provide power to the LEDs 108 such that the bracket 106 may not include the conducting pins to receive external power.

The lens 104 of the lamp assembly 100 may include one or more features 112 to amplify or direct light illuminated from the LEDs 108. For example, the lens 104 may include a plurality of ridges configured to direct light rays from the LEDs 108 in a particular direction, such as to spread the light more effectively across a wider area. In some instances, the focusing features 112 may correspond to an LED of the lamp assembly 100. For example and as shown in FIGS. 1 and 2, the lens 104 may include a plurality of circular ridges located in front one or more corresponding pairs of LEDs 108 housed within the lamp assembly 100 to focus the light generated by the LEDs to shine perpendicular away from the lens. Additional focusing features 112 may also aid in directing the light from the LEDs to shine in a substantially perpendicular direction from the lens 104 surface. In general, however, the lens 104 may include any shape or features to enhance or direct the illumination of the LEDs 108 from within the lamp assembly 100.

As noted above, a fail-safe lamp circuit 110 may be included within the lamp housing 102 between the lens 104 and the bracket 106. The circuit 110 may comprise a circuit board 114 upon which one or more circuit components are mounted. The components of the circuit may be electrically connected through the circuit board 114. In some examples, the circuit board 114 may include one or more power pins to receive power or other electrical signals from an external device, such as a battery of a vehicle. One or more conductive pins may extend from the rear of the circuit board toward the bracket 106 of the lamp assembly 100 to receive the power or other signals for the circuit 110 housed within the assembly. Configuration and operation of the fail-safe lamp circuit 110 is described in greater detail below.

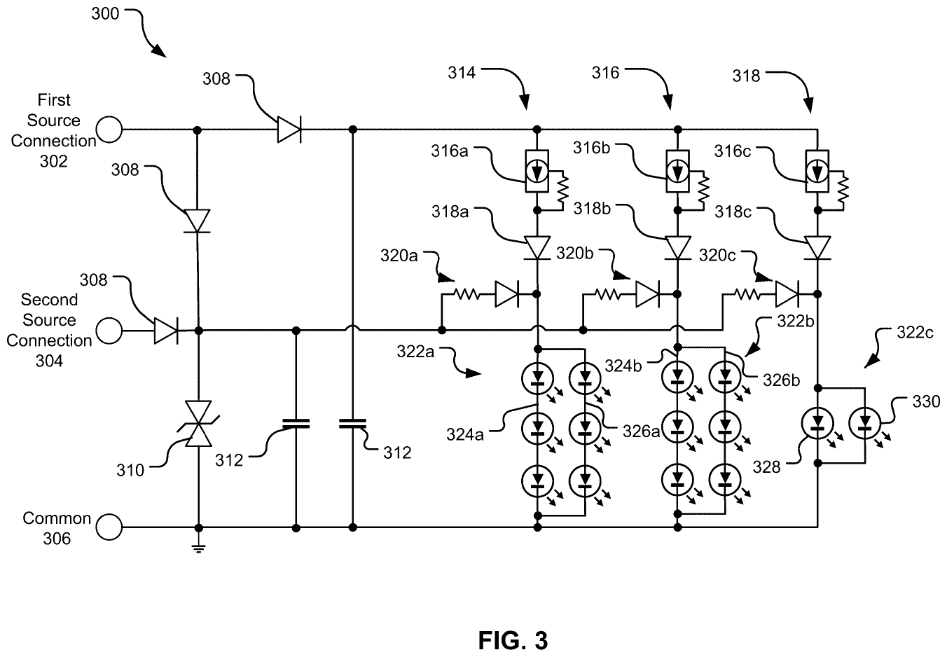

One example of a fail-safe lamp circuit 110 is illustrated in FIG. 3 as fail-safe circuit 300. As noted above, the fail-safe circuit 300 may include a printed circuit board (PCB) housed within the lamp assembly 100 of FIGS. 1 and 2. The components of the fail-safe circuit 300 may be electrically connected as described below through the PCB and, in some instances, be located on the PCB to correspond to the features of the lens 104. For example, the LEDS of the circuit 300 may be located on the PCB corresponding to a light directing feature of the lens.

As also mentioned above, the circuit 300 may include one or more conductive pins to receive power or electrical signals from an external source, such as a battery of a vehicle. The particular circuit 300 of FIG. 3 includes three such conductive pins that may extend through the bracket 106 of the lamp assembly 100, although more or fewer such conductive pins may be present. In this example, the circuit 300 includes a first source conductive pin 302 to receive a first power signal, a second source conductive pin 304 to receive a second power signal, and a common pin 306 to receive a common or ground signal. The particulars of the first power signal, the second power signal, and/or the common signal may vary from application to application of the fail-safe lamp assembly. For example, the first power signal received on the first source conductive pin 302 may correspond to a power signal generated by a vehicle's control system in response to a driver pressing the brake pedal to indicate to other drivers, through the illumination of the LEDs of the circuit, that the brake pedal has been pressed. The first power signal may include an alternating current (AC) signal or a direct current (DC) signal. The voltage and current of the first power signal may also vary based on the power source to which the conductive pins 302-306 are connected.

In a similar manner, the second power signal received on the second power conductive pin 304 may correspond to a power signal generated by a vehicle's control system in response to other operations of the vehicle. In the case of the lamp assembly 100 being a brake light assembly, the second power signal may correspond to a running light operation of the vehicle. In general, the first source connection 302 and the second source connection 304 may both be connected to the same power source such that each connection receives the same voltage and/or current from the power source. Control of the power signal to the connections 302, 304 may be controlled by the vehicle's control system. For example, application of the power signal at the first source connection 302 and the second source connection 304 may cause the LEDs to be brighter than application of the power signal to the second source connection 304 alone. Similar to the first power signal, the second power signal may include an AC signal or a DC signal, the values or aspects of which may vary based on the power source and vehicle control. The common conductive pin 306 may provide a return path for the power signal to the connected power source and may or may not be connected to ground or other reference node of a power source.

In general, the fail-safe lamp circuit 300 includes one or more LED circuits 314-318 to receive a power signal (such as the first power signal 302 and/or second power signal 304) and illuminate one or more LEDs of the LED circuit. Each of the power signals 302, 304 may be connected to one or more isolation diodes 308 and capacitors 312, including a capacitor connected between each of the voltage signals 302, 304 and the common connector 306. In one example, the fail-safe lamp circuit 300 may include a transient-voltage-suppression diode 310 to prevent damage to components of the circuit from a voltage strike. In addition, the fail-safe lamp circuit 300 may include a first LED circuit 314. The first LED circuit 314 may include a linear regulator 316a comprising an input in electrical communication with the first power signal. The linear regulator 316a may be configured to limit the current to a connected string of LEDs 322a regardless of the voltage of the first power signal 302. An output of the linear regulator 316a may be in electrical communication with an input to a diode 318a, the output of which may be connected to an input of a string of LEDs 322a. The current at the output of the from the linear regulator 316a and diode 318a combination may be utilized to power the LEDs 322a in response to the first power signal 302 received at the circuit 300.

The LEDs 322a of the first LED circuit 314 may illuminate as the current from the linear regulator 316a and diode 318a combination passes through the LEDs. In some implementations, the first LED circuit 314 may include a first string of LEDs 324a and a redundant second string of LEDs 326a connected in parallel with the first string of LEDs. In the particular example illustrated in FIG. 3, the first string of LEDs 324a comprises three LEDs connected in series. The second string of LEDs 326a may include the same number of LEDs, in this case three LEDs, also connected in series with each other. The second string of LEDs 326a may also be connected in parallel to the first string of LEDs 324a such that the current output from the linear regulator 316a and diode 318a combination passes through all of the LEDs in both strings 324a, 326a. Stated differently, the current is shared between the first string of LEDs 324a and the second string of LEDs 326a such that each LED is illuminated based on the shared current of the first power signal.

The second power signal 304 may also provide a current to the LED strings 324a, 326a to power the LEDs. In particular, the second power signal 304 may be provided through a resistor and diode combination 320a connected in series. A linear regulator may not be needed on the second power input to the LED strings 324a, 326a as the current from the second power signal 304 may be low enough such that current regulation may not be needed. As explained above, the fail-safe lamp may receive two power signals for different operations of the vehicle, such as a first power signal 302 to indicate braking of the vehicle and a second power 304 to operate as a running lamp. Thus, the second power signal 304 may be consistently provided to the LEDs of the first LED circuit 314 to provide a constant illumination of the LEDs while the first power signal 302 may increase the illumination of the LEDs during braking of the vehicle.

In some instances, one or more of the LEDs of the first LED circuit 314 may become broken or otherwise fail such that current no longer flows through the LED and through the corresponding string of LEDs. This may result in the entire string of LEDs losing current such that no LEDs on the affected string are illuminated. For example, one or more of the LEDs of the first LED string 324a of the first LED circuit 314 may fail such that current no longer can flow through the failed LED, creating an open in the first LED string 324a. Previous lamp assemblies allow one or more LED strings to fail such that the overall illumination from the lamp assembly is dimmed. In the fail-safe lamp circuit 300 of FIG. 3, however, the first LED circuit 314 includes a redundant second LED string 326a connected in parallel to the first LED string 324a. In this configuration, rather than the lamp assembly losing the illumination from the first LED circuit 314, the current through the first LED circuit 314 may flow through the second LED string 326a. In particular, all of the current provided from the second power signal 304 or from the linear regulator 316a may flow through the second LED string 326a. As the brightness of an LED corresponds to the current flowing through the LED, the first LED circuit 314 may provide a similar illumination from the second LED string 326a in the presence of a failure on the first LED string 324a. Stated differently, the first LED string 324a and the second LED string 326a may each receive 50% of the provided current prior to a failure of an LED of the circuit. Upon the occurrence of an LED failure on the first LED string 324a, the current may be redirected to the second LED string 326a such that the second string receives most or all of the provided current. In this manner, the illumination of the LEDs from the first LED circuit 314 may remain constant or near constant through the failure of one or more of the LEDs of the circuit.

It should be appreciated that the redundant features of the first LED circuit 314 apply for a failure of an LED of the second LED string 326a. For example, a failure of an LED of the second LED string 326a may cause the current through the first LED circuit 314 to flow through the first LED string 324a such that the overall illumination provided by the first LED circuit 314 remains similar through a fault of one of the LEDs. In this manner, the first LED circuit 314 may provide a redundancy to maintain a level of illumination through a failure in the first LED string 324a or the second LED string 326a.

In addition, the fail-safe lamp assembly may include more than one LED circuit to provide additional lamp illumination. In the example illustrated in FIG. 3, the fail-safe lamp circuit 300 may include a second LED circuit 316 and a third LED circuit 318. It should be appreciated that the fail-safe lamp circuit 300 may include any number of such LED circuits to provide multiple LED strings for the lamp assembly. Further, each LED circuit of the fail-safe lamp circuit 300 may include more or fewer LEDs than discussed herein. For example, the first LED circuit 314 and the second LED circuit 316 each include six LEDs, while a third LED circuit 318 includes two LEDs. Each string of the LED circuits 314-318 may also include more or fewer LEDs than illustrated, such as four LEDs, five LEDs, six LEDs, etc. connected in series.

As shown in the circuit 300 of FIG. 3, a second LED circuit 316 may be included to provide a second set of redundant LED strings. In particular, the second LED circuit 316 may include a linear regulator 316b comprising an input in electrical communication with the first power signal and configured to limit the current to a connected string of LEDs 322b regardless of the voltage of the first power signal 302. An output of the linear regulator 316b may be in electrical communication with an input to a diode 318b, the output of which may be connected to an input of a string of LEDs 322b. The current at the output of the from the linear regulator 316b and diode 318b combination may be utilized to power a first string of LEDs 324b and a redundant second string of LEDs 326b connected in parallel with the first string of LEDs. The second power signal 304 may also provide a current to the LED strings 324b, 326b to power the LEDs of the second LED circuit 316. In particular, the second power signal 304 may be provided through a resistor and diode combination 320b connected in series between the second power signal and the LED strings 324b, 326b.

The first string of LEDs 324b and the second string of LEDs 326b of the second LED circuit 316 each include three LEDs connected in series. The second string of LEDs 326b may also be connected in parallel to the first string of LEDs 324b such that the current output from the linear regulator 316b and diode 318b combination is shared between the first string of LEDs 324b and the second string of LEDs 326b such that each LED is illuminated based on the shared current of the first power signal. The second power signal 304 may also provide a current to the LED strings 324b, 326b of the second LED circuit 316 through a resistor and diode combination 320b connected in series between the low power signal 304 and the parallel LED strings 324b, 326b.

The second LED circuit 316 may provide a similar redundancy against a failed LED as described above with relation to the first LED circuit 314. In particular, the second LED string 326b may receive the total current through the second LED circuit 314 in the event of a failure of an LED of the first LED sting 324b to maintain a brightness of the LEDs of the second LED circuit 316.

The fail-safe circuit 300 may include a third LED circuit 318 of redundant LED strings. The third LED circuit 318 may also include a linear regulator 316c connected to the first power signal 302. An output of the linear regulator 316c may be in electrical communication with an input to a diode 318c, the output of which may be connected to an input of a string of LEDs 322c. The current at the output of the from the linear regulator 316c and diode 318c combination may be utilized to power a first LED 328 and a redundant second LED 330 connected in parallel with the first LED. As above, the current through third LED circuit 318 may be shared between the first LED 328 and the second LED 330 such that each LED is illuminated based on the shared current of the third LED circuit. The second power signal 304 may also provide a current to the LEDs 328, 330 of the third LED circuit 318 through a resistor and diode combination 320c connected in series between the low power signal 304 and the parallel connected LEDs. The first LED 328 and the second LED 330 of the third LED circuit may provide a redundancy to each other akin to the LED circuits described above in that, if the first LED 328 fails, the second LED 330 may receive the current through the third LED circuit 318 and vice versa.

The redundant LEDs of the fail-safe circuit 300 may be oriented within the fail-safe indicator lamp 100 to take advantage of the redundant aspect of the circuit. For example, FIG. 2 illustrates one possible configuration of the LEDs of the fail-safe circuit 300. In particular, the LEDs of a first string of an LED circuit 314-318 may be paired with the corresponding second string of the LED circuit. As shown in FIG. 2, the LEDs 350a-c of a first string of an LED circuit may be oriented within the lamp assembly 100 adjacent to or otherwise near the LEDs 352a-c of a second string of the same LED circuit. In the illustrated example, the first string may comprise three LEDs 350a-c and the second string may comprise three corresponding LEDs 352a-c. The first string of LEDs 350a-c and the second string of LEDs 352a-c of a first LED circuit (such as LED circuit 314 of FIG. 3) may be paired along the left side of the lamp assembly 100, although the location of the LEDs may be any location within the assembly. In general, however, each LED of the lamp assembly 100 may be located within the lamp near or adjacent to a corresponding LED such that failure of an LED may result in the corresponding LED to increase its illumination to account for the failed LED.

In a similar manner, the LEDs 354a-c of a first string of a second LED circuit (such as LED circuit 316 discussed above) may also be oriented within the lamp assembly 100 adjacent to or near the LEDs 356a-c of a second string of the same LED circuit. In the lamp assembly 100 of FIG. 2, the first string of LEDs 354a-c and the second string of LEDs 356a-c of the second LED circuit 316 may be paired along the right side of the lamp assembly 100, although other locations within the assembly may be used. LEDs of additional LED circuits may also be included in the lamp assembly 100, such as third LED circuit 318 of circuit 300. The LEDs of the third LED circuit 318 may be located in a center portion of the lamp assembly as LED 358 and LED 360. These LEDs may correlate to LED 328 and LED 330 of circuit 300 as a redundant pair. Similar to the LEDs of other LED circuits, LED 328 and LED 330 may be located near or adjacent to each other such that the illumination lost from the failure of one of the LEDs may be provided by the redundant LED.

In some instances, each LED pair may be oriented within the lamp assembly 100 corresponding to one or more of the focusing features 112 of the lens 104. This orientation within the lamp assembly 100 may allow the LEDs to provide directed illumination through the lens 104. Further, the failure of an LED or a string of LEDs may not reduce the overall illumination of the lamp assembly 100 through the operation of the circuit 300 described above. In particular, the current through a failed LED or LED string may be redirected to a redundant LED or LED string such that the LEDs may transition from operating with a shared current to operating non-shared current.

Although each of the LED circuits 314-318 are described above and illustrated as including two LED strings or two LEDs connected in parallel, it should be appreciated that each LED circuit may include more than two LED paths. For example, LED circuit 314 may include three LED strings, four LED strings, etc. all connected in parallel such that a provided current flows through each of the LED strings. Upon the failure of an LED on one string, the remaining current may be shared with the remaining LED strings such that the illumination from the remaining strings may compensate for the fault. The LEDs of the strings of an LED circuit may be situated on the lamp assembly 100 as described above such that the redundant LEDs may provide compensation illumination for the failed LEDs.

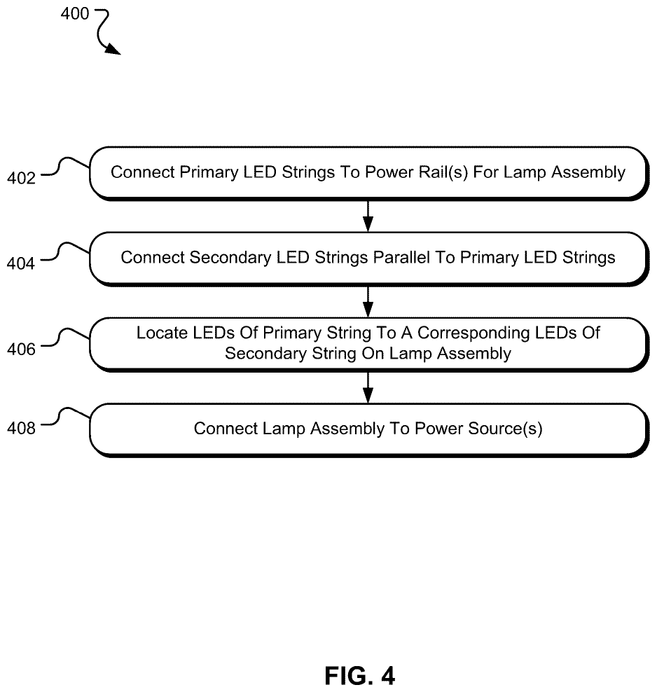

FIG. 4 is a representative flowchart of a method for utilizing a redundant, fail-safe indicator light of vehicle according to aspects of the present disclosure. For example, the lamp assembly 100 and circuit 300 described herein may be utilized for the method 400. For example, primary LED strings for a lamp assembly may be connected to one or more power rails in operation 402. As illustrated in the lamp circuit 300 of FIG. 3, a first string of LEDs 324a of first LED circuit 314 may be connected to the first power rail 302 and the second power rail 304. In a similar manner, the first string of LEDs 324b of the second LED circuit 316 and first LED 328 of the third LED circuit 318 may also be connected to the power rails. In operation 404, a secondary, redundant string of LEDs or single LED may be connected in parallel to the first strings of LEDs. For example, a second string of LEDs 326a may be connected in parallel to the first string of LEDs 324a of the first LED circuit 314, a second string of LEDs 326b may be connected in parallel to the first string of LEDs 324b of the second LED circuit 316, and a second LED 330 may be connected in parallel to the first LED 328 of the third LED circuit 318. As mentioned above, the circuit 300 may include more than the three LED circuits illustrated and each LED circuit may include more than one redundant LED connected in parallel to the primary or first string.

At operation 406, the LEDs of the primary string and the secondary string for each of the LED circuits of the lamp assembly may be located on the lamp assembly in a paired configuration. For example, an LED of a primary string may be located next to or near a corresponding LED of a secondary string. The location of the LEDs in this manner on the lamp assembly may ensure that the loss of illumination from a failed LED may be compensated by the corresponding secondary string LED as the LED of the secondary string becomes brighter due to the redirected current from the failed first string. In some instances, the secondary string LED may receive twice the normal current in response to the failure of the first LED string and provide twice the illumination. Thus, the LEDs of the lamp circuit may be located within the lamp assembly 100 in a manner to take advantage of this fail-safe feature of the parallel-connected LED strings and provide the same or significantly the same illumination despite the failure of one or more LEDs of the circuit. In operation 408, the lamp assembly 100 may be connected to one or more power sources to power the circuit and provide the illumination from the lamp assembly.

In one implementation, the lamp assembly described herein may be utilized for a vehicle indicator, such as a brake light, a running light, a turn signal light, etc. As such, the components of the lamp assembly may be chosen for the specific application of the assembly on the vehicle. For example, a lamp assembly intended for use as a brake light may include a red tinted lens while a lamp assembly intended as a turn signal indicator may include a yellow tinted lens. In addition, the shape of the lamp assembly may be based on the intended use of the lamp and a particular make and model of a vehicle. As should be appreciated, different vehicle manufacturers have differently shaped receptacles for the various indicator lights for the vehicle. The lamp assemblies and methods described herein may include any shape of a mounting bracket and/or lens for the various types of vehicular lights.

In addition, vehicular lights may have mandated luminous intensities as set out by federal standards. For example, turn signal lamps may have a 0.3 candela of minimum luminous intensity while a taillamp (without braking) may have a 0.05 candela of minimum luminous intensity. The various components of the lamp circuit discussed above, such as the LEDs and other components, may be selected to provide at least the minimum candela for the type of vehicular lamp. As explained above, the circuit may include paralleled strings of LEDs running side by side on a circuit board so that drive currents are shared equally between paired strings. If one or more LEDs fail in one string, an evenly split drive current between the paired strings of LEDs shifts so that the remaining intact string of LEDs now receives the entirety of the drive current, causing the secondary string of LEDs to increase their illumination. Coupled with the lamp lensing, the remaining LED string maintains enough illumination to appear fully operational and to pass the photometric requirements of the lamp. In one particular implementation, the components may be selected to satisfy the Federal Motor Vehicle Safety Standards (FMVSS) regulations, such as that set out in FMVSS 108.

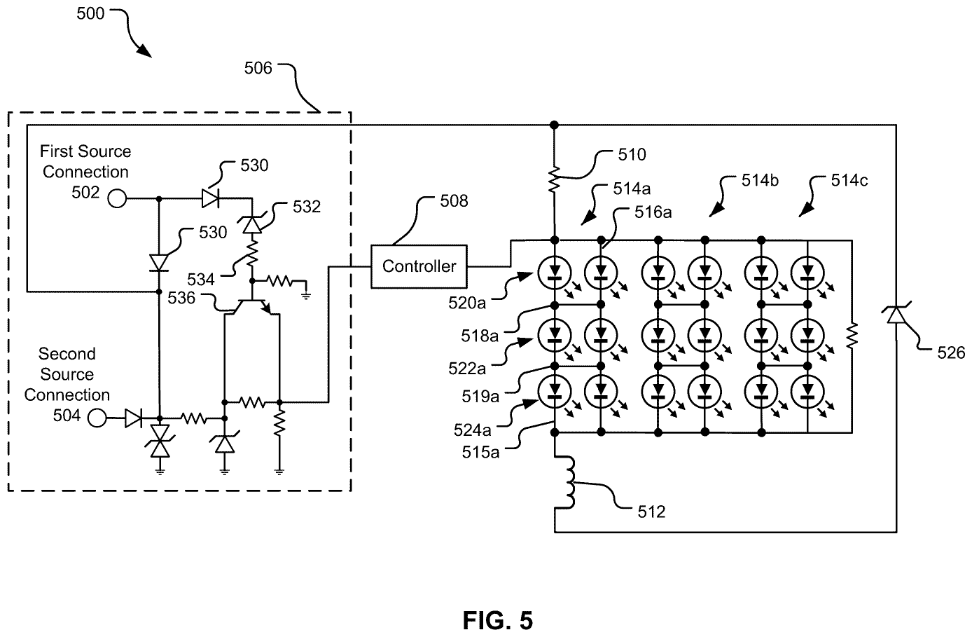

FIG. 5 is a representative circuit 500 for a second embodiment of a fail-safe indicator light for a vehicle with redundancy. Many of the components of the circuit 500 of FIG. 5 are similar to those described above with relation to FIG. 3. For example, the circuit 500 may include a connector portion 506 to connect the circuit to one or more power supplies. The connector portion 506 may include a first conductive pin 502 to connect to a first source and a second conductive pin 504 to connect to a second source. As above, the particulars of the first power signal, the second power signal, and/or a common signal may vary from application to application of the fail-safe lamp assembly. In addition, the connector portion 506 of the fail-safe lamp circuit 500 may include one or more isolation diodes 530, resistors 534, transient-voltage-suppression diodes 532, and one or more switches 536 arranged as shown. In one particular implementation, the one or more switches 536 may include a transistor, although other switch devices are contemplated. The components of the connector portion 506 may control the voltage and/or current supplied to the controller 508 (discussed below) from the first source connection 502 and/or the second source connection 504 to ensure proper voltage and/or current levels to the controller and/or the rest of the fail-safe circuit 500. The components of the connector portion 506 may also be arranged and/or selected to prevent damage to other components of the circuit 500 due to extreme conditions, such as a voltage spike.

The connector portion 506 of the circuit 500 may provide an input signal to a controller 508. The input signal may correspond to an energizing of the first source connection 502 and/or the second source connection 504. The controller 508 may be any programmable processing unit or microchip that converts the input signal to an output signal. The output signal of the controller 508 may correspond to the input signal as processed by the controller. In some instances, the controller 508 may not be included in the circuit 500, similar to the circuit design of FIG. 3. In this instance, however, the output may be provided to one or more LED circuits 514a-c to provide the redundancy of the fail-safe circuit.

In particular, the circuit 500 may include a first LED circuit 514a connected to the output of the controller 508 to receive the output signal of the controller. The first LED circuit 514a may include a first string of LEDs 515a and a second string of LEDs 516a connected in parallel. In the implementation shown in the circuit 500, each string 515a, 516a of the first LED circuit 514a includes three LEDs connected in series, although more or fewer LEDs may be connected in each string. The second LED circuit 514b and the third LED circuit 514c may include a similar configuration, with each including a respective first string of LEDs and a second string of LEDs connected in parallel. Although illustrated as including three such LED circuits 514a-c, it should be appreciated that any number of LED circuits may be connected together to receive the output of the controller 508. In addition, the fail-safe lamp circuit 500 may include one or more inductors 512, transient-voltage-suppression diodes 526, and/or resistors 510 arranged as shown as connected to the LED circuits 514.

In addition, one or more of the LED circuits 514a-c may include a bridge connections 518, 519 between paired LEDs of the first LED string 515 and the second LED string 516. For example, the first LED circuit 514a may include three LEDs connected in series along the first string 515a and three LEDS connected in series along the second string 516a. The first LED of the first string 515a may be paired with the first LED of the second string 516a to form a first paired LEDs 520a. Similarly, the second LED of the first string 515a may be paired with the second LED of the second string 516a to form a second paired LEDs 522a and the third LED of the first string 515a may be paired with the third LED of the second string 516a to form a third paired LEDs 524a. The corresponding LEDs of the second LED circuit 514b and the third LED circuit 514c may also be paired in a similar manner. A first bridge connector 518a may connect the first LED string 515a to the second LED string 516a between the first paired LEDs 520a and the second paired LEDs 522a. A second bridge connector 519a may also connect the first LED string 515a to the second LED string 516a between the second paired LEDs 522a and the third paired LEDs 524a. Additional LED circuits 514b, 514c may also include a similar ladder configuration between paired LEDs.

This ladder configuration of the LED circuit 500 may add additional redundancy to the LEDs. In particular, current may continue to be provided to the LEDs of a string even following the failure of another LED of the string. For example, in the circumstance in which the first LED of the second string 516a were to fail, current may flow through bridge connector 518a to the other LEDs of the second string to keep those LEDs illuminated. A similar flow of current to the third LED of the second string 516a may occur in circumstances in which the first LED and the second LED of the second string fails. The ladder configuration may also provide current to LEDs of the first string 515a in a similar manner. Through this configuration, the LED circuits 514 of the fail-safe circuit 500 may include additional redundancy to ensure illumination of the remaining LEDs through the failure of one or more LED components.

Although various representative embodiments of this invention have been described above with a certain degree of particularity, those skilled in the art could make numerous alterations to the disclosed embodiments without departing from the spirit or scope of the inventive subject matter set forth in the specification. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected to another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention.

Various modifications and additions can be made to the exemplary embodiments discussed without departing from the scope of the present invention. For example, while the embodiments, also referred to as implementations or examples, described above refer to particular features, the scope of this invention also includes embodiments having different combinations of features and embodiments that do not include all of the described features. Accordingly, the scope of the present invention is intended to embrace all such alternatives, modifications, and variations together and in various possible combinations of various different features of different embodiments combined to form yet additional alternative embodiments, with all equivalents thereof.

While specific embodiments are discussed, it should be understood that this is done for illustration purposes only. A person skilled in the relevant art will recognize that other components and configurations may be used without parting from the spirit and scope of the disclosure. Thus, the above description and drawings are illustrative and are not to be construed as limiting. Numerous specific details are described to provide a thorough understanding of the disclosure. However, in certain instances, well-known or conventional details are not described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment”, or similarly “in one example” or “in one instance”, in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Various features and advantages of the disclosure are set forth in the description above, and in part will be obvious from the description, or can be learned by practice of the herein disclosed principles. The features and advantages of the disclosure can be realized and obtained by means of the instruments and combinations particularly pointed out in the appended claims.

Features described above as well as those claimed below may be combined in various ways without departing from the scope hereof. The previous examples illustrate some possible, non-limiting combinations. It should thus be noted that the matter contained in the above description or shown in the accompanying drawings should be interpreted as illustrative and not in a limiting sense. The above-described embodiments should be considered as examples of the present disclosure, rather than as limiting its scope. In addition to the foregoing embodiments of inventions, review of the detailed description and accompanying drawings will show that there are other embodiments of such inventions. Accordingly, many combinations, permutations, variations, and modifications of the foregoing embodiments not set forth explicitly herein will nevertheless fall within the scope of this disclosure. The following claims are intended to cover generic and specific features described herein, as well as all statements of the scope of the present methods, systems, and devices, which, as a matter of language, might be said to fall there between.

What is claimed is:

1. A lamp assembly for a vehicle comprising:
a mounting bracket for mounting the lamp assembly to the vehicle;
a lens connected to the mounting bracket to form an interior of the lamp assembly; and
a lighting circuit within the interior of the lamp assembly, the lighting circuit comprising:
a first LED in electrical communication with a first power rail to receive a power signal from a power source connected to the first power rail, the power signal comprising a current component; and
a second LED connected in parallel with the first LED, the second LED in electrical communication with the first power rail to receive the first power signal from the power source, the current component of the power signal shared between the first LED and the second LED,
wherein the current component of the power signal is provided to the second LED upon a failure of the first LED to increase an illumination of the second LED.

2. The lamp assembly of claim 1, wherein the lighting circuit further comprises:
a first string of a plurality of LEDs comprising the first LED; and
a second string of a plurality of LEDs comprising the second LED, wherein the second string of the plurality of LEDs is connected in parallel to the first string of the plurality of LEDs.

3. The lamp assembly of claim 2 further comprising:
a second lighting circuit comprising a third string of a plurality of LEDs in electrical communication with the first power rail to receive the first power signal and a fourth string of a plurality of LEDs connected in parallel with the third string of the plurality of LEDs.

4. The lamp assembly of claim 3 further comprising:
a third lighting circuit comprising a third LED in electrical communication with the first power rail to receive the first power signal and a fourth LED connected in parallel with the third LED.

5. The lamp assembly of claim 1, wherein the lighting circuit further comprises:
a circuit board; and
an interface to the power source on the circuit board.

6. The lamp assembly of claim 5, wherein the first LED is located adjacent to the second LED on the circuit board.

7. The lamp assembly of claim 1, wherein the lighting circuit further comprises:
a linear current regulator connected in series between the first power rail and the first LED and the second LED.

8. The lamp assembly of claim 1, wherein the lighting circuit further comprises:
a second power rail to receive a second power signal from the power source.

9. The lamp assembly of claim 8, wherein the lighting circuit further comprises:
a resistor and a diode connected in series between the second power rail and the first LED and the second LED.

10. The lamp assembly of claim 8, wherein the first power signal from the power source is provided on the first power rail in response to an operating condition of the vehicle.

11. The lamp assembly of claim 2, wherein the lighting circuit further comprises:
an electrical connector between the first string of the plurality of LEDs and the second string of the plurality of LEDs, the electrical connector connecting the first LED and the second LED in parallel.

12. A method for a providing illumination from a vehicular lamp assembly, the method comprising:
mounting, via a mounting bracket, the vehicular lamp assembly to a vehicle, the vehicular lamp assembly comprising the mounting bracket, a lens, and a lighting circuit contained within the vehicular lamp assembly between the mounting bracket and the lens; and
connecting a power source to the vehicular lamp assembly via one or more power connectors of the lighting circuit,
wherein the lighting circuit comprises:
a circuit board;
a first LED on the circuit board and in electrical communication with a first power rail to receive a power signal from a power source connected to the first power rail via the one or more power connectors, the power signal comprising a current component; and
a second LED on the circuit board and connected in parallel with the first LED, the second LED in electrical communication with the first power rail to receive the first power signal from the power source via the one or more power connectors, the current component of the power signal shared between the first LED and the second LED,
wherein the current component of the power signal is provided to the second LED upon a failure of the first LED to increase an illumination of the second LED.

13. The method of claim 12, wherein the first LED comprises a first string of a plurality of LEDs and the second LED comprises a second string of a plurality of LEDs.

14. The method of claim 13 further comprising:
providing a second lighting circuit comprising a third string of a plurality of LEDs in electrical communication with the first power rail to receive the first power signal and a fourth string of a plurality of LEDs connected in parallel with the third string of the plurality of LEDs.

15. The method of claim 12 further comprising:
locating the first LED is located adjacent to the second LED on the circuit board.

16. The method of claim 13 further comprising:
locating each LED of the first string of the plurality of LEDs adjacent to a corresponding LED of the second string of the plurality of LEDs on the circuit board.

17. The method of claim 12, wherein the lighting circuit comprises a second power rail, the method further comprising:
connecting the first power rail to the power source via a first connector of the one or more power connectors to receive a first power signal and the second power rail to the power source via a second connector of the one or more power connectors to receive a second power signal.

18. The method of claim 17, wherein the first power signal from the power source is provided on the first power rail in response to an operating condition of the vehicle.

19. The method of claim 13, wherein the lighting circuit comprises:
an electrical connector between the first string of the plurality of LEDs and the second string of the plurality of LEDs, the electrical connector connecting the first LED and the second LED in parallel.
